(19) United States
(12) Patent Application Publication
(10) Pub. No.: US 2012/0036276 A1
(43) Pub. Date: Feb. 9, 2012

(54) STREAMING SERVICE GATEWAY AND METHOD FOR PROVIDING STREAMING SERVICE

(75) Inventors: CHIA-HUNG CHIEN, Tu-Cheng (TW); CHUN-WEN WANG, Tu-Cheng (TW)

(73) Assignee: HON HAI PRECISION INDUSTRY CO., LTD., Tu-Cheng (TW)

(21) Appl. No.: 13/150,373

(22) Filed: Jun. 1, 2011

(30) Foreign Application Priority Data
Aug. 6, 2010 (CN) 201010247299.2

(51) Int. Cl. G06F 15/16

(52) U.S. Cl. 709/231

(57) ABSTRACT

A streaming service gateway includes a streaming service adapter, a transcoding module, and a streaming interface. The streaming service adapter communicates with at least one streaming server through at least one of a plurality of streaming protocols. The transcoding module transforms the streaming content from the streaming service adapter into a predetermined format. The streaming interface receives the streaming content with the predetermined format and provides the streaming content with the predetermined format to a streaming client device through a uniform streaming protocol.

### BACKGROUND

1. Technical Field

The disclosure generally relates to a streaming service gateway and a method for providing streaming service.

2. Description of Related Art

Streaming contents, such as video, photo contents, are widely used on the Internet for sharing information. However, this streaming content is usually provided by different websites. For example, YouTube™ or Hulu™ may provide the same or different content. These websites may use different transmitting protocols for transmitting content, such as Real-time Transport Protocol (RTP), Microsoft Media Server (MMS), Real Time Streaming Protocol (RTSP), and this content may be encoded in different formats, such as RMVB, AVI, WMV and FLV. In this way, a client, such as an electronic device, must have different protocol programs installed for supporting these transmitting protocols to receive the content from the different websites, and must have corresponding decoding firmware or corresponding decoding software installed to decode these different formats.

It is difficult to receive or display the content in a non-extensible device, such as, a home network device with non-extensible firmware.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block view of a streaming service system in one embodiment.

FIG. 2 is a flowchart of a method for providing streaming service in one embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used herein, refers to logic embodied in hardware or firmware, or to a collection of software instructions, written in a programming language such as Java, C, or Assembly. One or more software instructions in the modules may be embedded in firmware, such as an EPROM. It is noteworthy, that modules may include connected logic units such as gates and flip-flops, and programmable units such as programmable gate arrays or processors. The modules described herein may be implemented as software and/or hardware modules and may be stored in any type of computer-readable medium or other computer storage device.

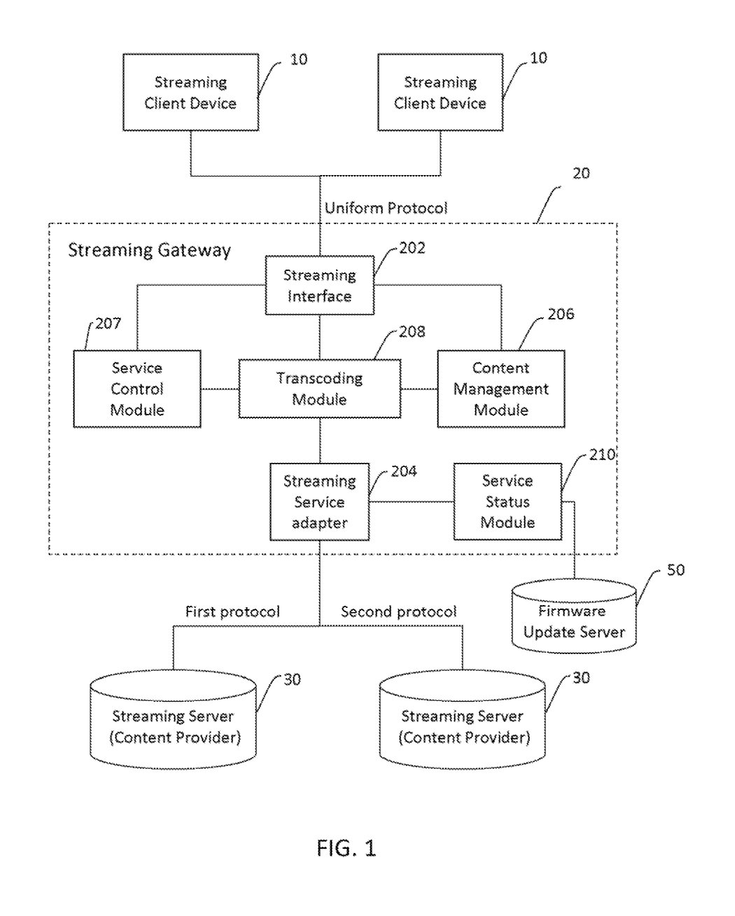

Referring to FIG. 1, in one embodiment, a streaming service system includes a plurality of streaming servers 30, a streaming service gateway 20, and a plurality of streaming client devices 10. The streaming service gateway 20 is interfaced between the plurality of streaming servers 30 and the plurality of streaming client devices 10. The plurality of streaming client devices 10 may include a computer, a portable digital device, or a smart phone. The streaming service gateway 20 may be a computer or an embedded electronic device. The plurality of streaming servers 30 are content providers such as websites, for providing streaming content through the Intranet or the Internet. The streaming content may include video, audio, and photo.

The streaming service gateway 20 includes a streaming interface 202, a transcoding module 208, a streaming service adapter 204, a content management module 206, a service control module 207, and a service status module 210. The transcoding module is connected between the streaming interface 202 and the streaming service adapter 204. The service control module 207 and content management module 206 are connected to the transcoding module 208. The service status module 210 is connected to the streaming service adapter 204.

The streaming service adapter 204 may receive the streaming content from the plurality of streaming servers 30. The streaming service adapter 204 may support a plurality of streaming protocols from the plurality of streaming servers 30. The streaming protocols may include Real-time Transport Protocol (RTP), Microsoft Media Server (MMS), or Real Time Streaming Protocol (RTSP). The streaming protocols supported by the streaming service adapter 204 may be extensible.

The transcoding module 208 may transform the streaming content from the streaming service adapter 204 into a uniform format. Formats of streaming content from the streaming service adapter 204 may include RMVB, AVI, WMV, and FLY. Decoders supported by the transcoding module 208 may be extensible. The uniform format of the streaming content may be predetermined. In one embodiment, the predetermined uniform format may include at least one format supported by Digital Living Network Alliance (DLNA).

The streaming interface 202 may receive requests from the plurality of streaming client devices 10. The streaming interface 202 can provide streaming content to the plurality of streaming client devices 10 through a uniform protocol. In one embodiment, the uniform protocol may include at least one of the protocols supported by DLNA.

The content management module 206 may provide a streaming content list from the streaming servers 30 to the streaming client device 10. Furthermore, the content management module 206 may update the streaming content list from the streaming servers 30 at a still interval or on demand of the streaming client device 10.

The service control module 207 may handle service requests from the streaming client device 10 to specific services and output the specific services to corresponding modules in the streaming service gateway 20.

The service status module 210 provides the plurality of streaming protocols and a plurality of decoders of the streaming content to the streaming service adapter 204 and the transcoding module 208. The service status module 210 is connected to a firmware update server 50. The service status module 210 checks if more streaming protocols, decoders or new firmware versions are available from the firmware update server 50.

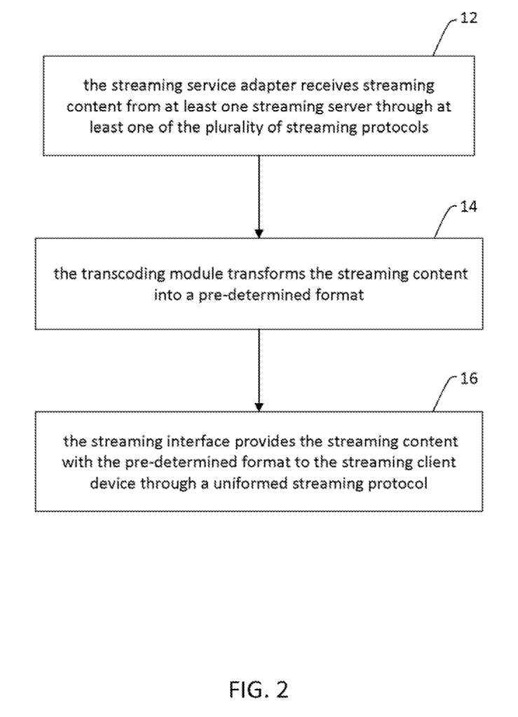

Referring to FIG. 2, a computer-implemented method for providing streaming service may include the following blocks.

In block 12, the streaming service adapter 204 receives streaming content from at least one streaming server 30 through at least one of the plurality of streaming protocols.

In block 14, the transcoding module 208 transforms the streaming content into a pre-determined format.

In block 16, the streaming interface 202 provides the streaming content with the pre-determined format to the streaming client device 10 through a uniform streaming protocol.

According to the method, the content management module 206 may further provide a streaming content list from the at least one streaming server 30 to the streaming client device 10, and update the streaming content list from the at least one streaming server 30 at a still interval or on demand of the streaming client device 10. The service status module 210 may provide a plurality of streaming protocols and a plurality of decoders of the streaming content. The service status module 210 may check if more streaming protocols, decoders, or new firmware versions are available.

While the present disclosure has been illustrated by the description of the embodiments thereof, and while the embodiments have been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

Depending on the embodiment, certain blocks of methods described may be removed, others may be added, and the sequence of blocks may be altered. It is also to be understood that the description and the claims drawn to a method may include some indication in reference to certain blocks. However, the indication used is only to be viewed for identification purposes and not as a suggestion as to an order for the blocks.

What is claimed is:

1. A streaming service gateway, comprising:
a streaming service adapter adapted to communicate with at least one streaming server through at least one of a plurality of streaming protocols;
a transcoding module adapted to transform streaming content from the streaming service adapter into a predetermined format; and
a streaming interface adapted to receive the streaming content with the predetermined format and provide the streaming content with the predetermined format to a streaming client device through a uniform streaming protocol.

2. The streaming service gateway of the claim 1 further comprising a content management module adapted to provide a streaming content list from the at least one streaming server to the streaming client device.

3. The streaming service gateway of the claim 2, wherein the content management module is adapted to update the streaming content list from the at least one streaming server at a still interval or on demand of the streaming client device.

4. The streaming service gateway of the claim 1 further comprising a service status module adapted to provide the plurality of streaming protocols and a plurality of decoders of the streaming content to the streaming service adapter and the transcoding module.

5. The streaming service gateway of the claim 4, wherein the service status module is adapted to check if more streaming protocols, decoders, or new firmware versions are available.

6. The streaming service gateway of the claim 5, wherein the plurality of streaming protocols supported by the streaming service adapter is extensible.

7. The streaming service gateway of the claim 5, wherein the plurality of decoders supported by the transcoding module is extensible.

8. The streaming service gateway of the claim 1, wherein the uniform streaming protocol between the streaming interface and the streaming client device is one of the protocols supported by Digital Living Network Alliance protocol.

9. The streaming service gateway of the claim 1, wherein the streaming content comprises video, audio, and photo.

10. A computer-implemented method for providing streaming service, comprising:
receiving streaming content from at least one streaming server through at least one of a plurality of streaming protocols;
transforming the streaming content into a predetermined format; and
providing the streaming content with the predetermined format to a streaming client device through a uniform streaming protocol.

11. The method of the claim 10 further comprising providing a streaming content list from the at least one streaming server to the streaming client device.

12. The method of the claim 11 further comprising updating the streaming content list from the at least one streaming server at a still interval or on demand of the streaming client device.

13. The method of the claim 10 further comprising providing the plurality of streaming protocols and a plurality of decoders of the streaming content by a service status module.

14. The method of the claim 13 further comprising checking if more streaming protocols, decoders, or new firmware version are available.

15. The method of the claim 14, wherein the plurality of streaming protocols is extensible.

16. The method of the claim 14, wherein the plurality of decoders is extensible.

17. The method of the claim 10, wherein the uniform streaming protocol is one of the protocols supported by Digital Living Network Alliance protocol.

18. The method of the claim 10, wherein the streaming content comprise video, audio, and photo.
